(19) United States
(12) Patent Application Publication
(10) Pub. No.: US 2023/0237620 A1
(43) Pub. Date: Jul. 27, 2023

(54) IMAGE PROCESSING SYSTEM AND METHOD FOR PROCESSING IMAGE

(71) Applicant: SONIC STAR GLOBAL LIMITED, ROAD TOWN (VG)

(72) Inventor: HUNG-HUI JUAN, TAIPEI CITY (TW)

(21) Appl. No.: 17/586,549

(22) Filed: Jan. 27, 2022

(51) Int. Cl. G06T 3/40; G06F 16/55; G06V 10/70

(52) U.S. Cl. CPC G06T 3/4076; G06F 16/55; G06V 10/87

(57) ABSTRACT

An image processing system with scalable models is provided. The image processing system comprises computing devices having a graphic analysis environment that includes instructions to execute an analysis process on a first image having a native resolution. The analysis process causes the one or more computing devices to perform operations includes: resampling the first image to generate a second image, wherein the second image has a resampled resolution greater than the native resolution in pixel number; detecting a plurality of first patches and a plurality of second patches in the first image and the second image, respectively, wherein the first patches and the second patches are detected by different detection models of a first scalable model collection according to sizes of the first image and the second image; and aggregating the first patches and the second patches. A method for processing an image with scalable models is also provided.

### FIELD

The present disclosure relates to an image processing system and a method for processing an image, and more particularly, to image content analysis using scalable model collections.

### BACKGROUND

Image recognition refers to the technology that includes the capacity in identifying places, logos, people, objects, buildings, and several other variables in digital images. In recent years, a drastic advance has been achieved in image recognition performance using deep learning. Deep learning is known as a method of machine learning using a multilayer neural network. In many cases, a convolutional neural network is employed as the multilayer neural network.

Generally, the deep learning models for image recognition are trained to take an image as input and output one or more labels describing the image. The set of possible output labels are referred to as target classes. Along with a predicted class, image recognition models may output a score related to how certain a model is that an image belongs to a class.

### BRIEF DESCRIPTION OF THE DRAWINGS

Aspects of the present disclosure are best understood from the following detailed description when read with the accompanying figures. It is noted that, in accordance with the standard practice in the industry, various structures are not drawn to scale. In fact, the dimensions of the various structures may be arbitrarily increased or reduced for clarity of discussion.

FIG. 1 illustrates a flow chart of an analysis process in image recognition according to some embodiments of the present disclosure.

FIG. 2 illustrates a graphical flow chart of some embodiments of the present disclosure.

FIG. 3A illustrates a schematic diagram of resizing the first image according to some embodiments of the present disclosure.

FIG. 3B illustrates a schematic diagram of resizing the first image according to some embodiments of the present disclosure.

FIG. 4 illustrates a schematic diagram of the patches detected in the images according to some embodiments of the present disclosure.

FIG. 5 illustrates a schematic diagram of the third image formed by aggregating the first patches and the second patches according to some embodiments of the present disclosure.

FIG. 6 illustrates a flow chart of an analysis process in image recognition according to some embodiments of the present disclosure.

FIG. 7 illustrates a schematic diagram of the patches detected in the images according to some embodiments of the present disclosure.

FIG. 8A illustrates a schematic diagram of resizing the first patch according to some embodiments of the present disclosure.

FIG. 8B illustrates a schematic diagram of resizing the first patch according to some embodiments of the present disclosure.

FIG. 9 illustrates a graphical flow chart of some embodiments of the present disclosure.

FIG. 10 illustrates an example of the classification result of some embodiments of the present disclosure.

FIG. 11 illustrates a schematic diagram of the image processing system of some embodiments of the present disclosure.

FIG. 12A illustrates an example of deep learning neural network.

FIG. 12B illustrates an example of image retrieval of some embodiments of the present disclosure.

FIG. 13 illustrates a flow chart of an analysis process in image recognition according to some embodiments of the present disclosure.

### DETAILED DESCRIPTION

The following disclosure provides many different embodiments, or examples, for implementing different features of the provided subject matter. Specific examples of elements and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper”, “on” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the terms such as “first”, “second” and “third” describe various elements, components, regions, layers and/or sections, these elements, components, regions, layers and/or sections should not be limited by these terms. These terms may be only used to distinguish one element, component, region, layer, or section from another. The terms such as “first”, “second”, and “third” when used herein do not imply a sequence or order unless clearly indicated by the context.

Image recognition is the task of identifying the objects of interest within an image and recognizing which category or class they belong to. Hence, the technique in image recognition may include the project of image classification and the project of object localization. Generally, image classification involves assigning a class label to the image, whereas object localization involves drawing a bounding box around one or more objects of interest in the image. To recognize the object(s) in the bounding box, the project of object localization may further broaden to locate the presence of object(s) with the bounding box and types or classes of the located objects in the image; such process may be called object detection.

Artificial intelligence has been applied in the field of image recognition. While different methods evolved over time, machine learning, in particular deep learning technology, has achieved significant successes in many image understanding tasks. Deep learning technology can analyze data with a logic structure similar to how a human would draw conclusions, and such applications use a layered structure of algorithms called an artificial neural network (ANN). The design of ANN is inspired by the biological neural network of the human brain, leading to a process of learning that's far more capable than that of standard machine learning models. In general, the successes of deep learning technology can credit to the development of efficient computing hardware and the advancement of sophisticated algorithms, and deep learning technology has thus provided a strong capacity to address substantial unstructured data.

In typical image recognition, an input image may be sequentially processed through a detection process, a classification process, and a metadata management process. In some commercialized examples, such as Google Photos, the image recognition service may automatically analyze photos and identify various visual features and subjects. By doing so, users can search for valuable information in the recognized images, such as who the people are, where the place is, and what the things are in the image. In the commercialized examples, the accuracy of image recognition can be improved by machine learning algorithms. Or in some advanced applications, a number of pre-trained deep learning algorithms or models can be utilized to classify the objects in photos. Therefore, how to efficiently select the models to detect and classify the objects in the photos should be considered.

In order to improve the efficiency of the image recognition, some embodiments of the present disclosure provide an image processing system with scalable models, which may select appropriate models for object detection and classification. Therefore, not only can the image be recognized efficiently, but the detection accuracy and the classification accuracy can both be improved since the selected models have exactly corresponded to the specification of the images and the objects therein. Such outstanding classification result may provide precise information for the use of image retrieval.

In some embodiments of the present disclosure, the image processing system with scalable models includes one or more computing devices, which are used to implement the tasks of image recognition. In some embodiments, the computing devices include a graphic analysis environment in which one or more applications or programs are executed thereon. For example, the application or the program executed on the computing devices may allow the users to input the images that have just been captured. For instance, the images captured by consumer electronics such as smartphone cameras or digital cameras can be real-time recognized. The integration of the camera function and image recognition may make the images classified properly and easy to view and check.

In other embodiments, the images are accessed from user-end or far-end storage devices. These storage devices can be the components of consumer electronics or centralized servers such as cloud servers. The abovementioned computing devices including the graphic analysis environment can be consumer electronics such as smart phones, personal computers, PDAs, or the like. In the case that the image recognition is running on far-end computing devices, the computing tasks can be executed by centralized computer servers which have incredible computing power. These centralized computer servers usually may provide the graphic analysis environment that is able to accommodate a large volume of requests from connected systems while also managing who has access to the resources, when they can access them, and under what conditions.

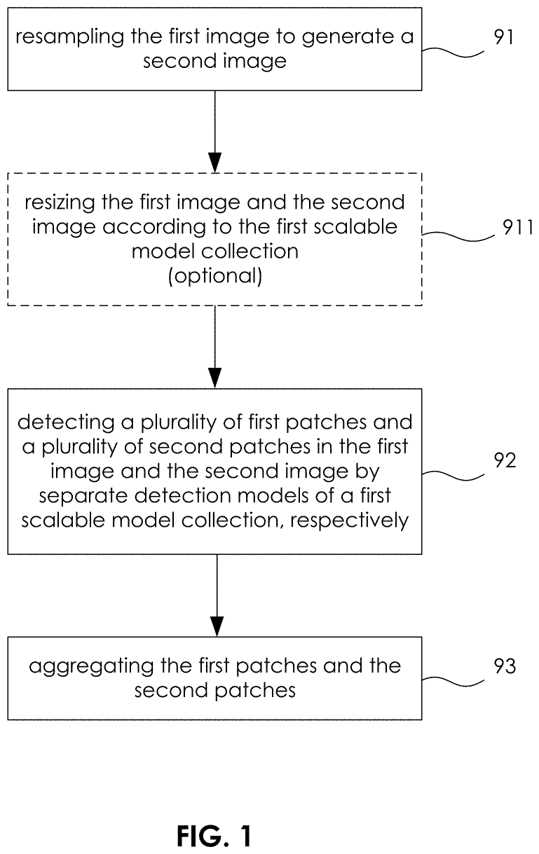

FIG. 1 illustrates a flow chart of an analysis process in image recognition according to some embodiments of the present disclosure, which includes the operation 91: resampling the first image to generate a second image; the operation 92: detecting a plurality of first patches and a plurality of second patches in the first image and the second image by separate detection models of a first scalable model collection, respectively; and the operation 93: aggregating the first patches and the second patches. These operations are executed according to the instructions of one or more computing devices involved in the analysis process.

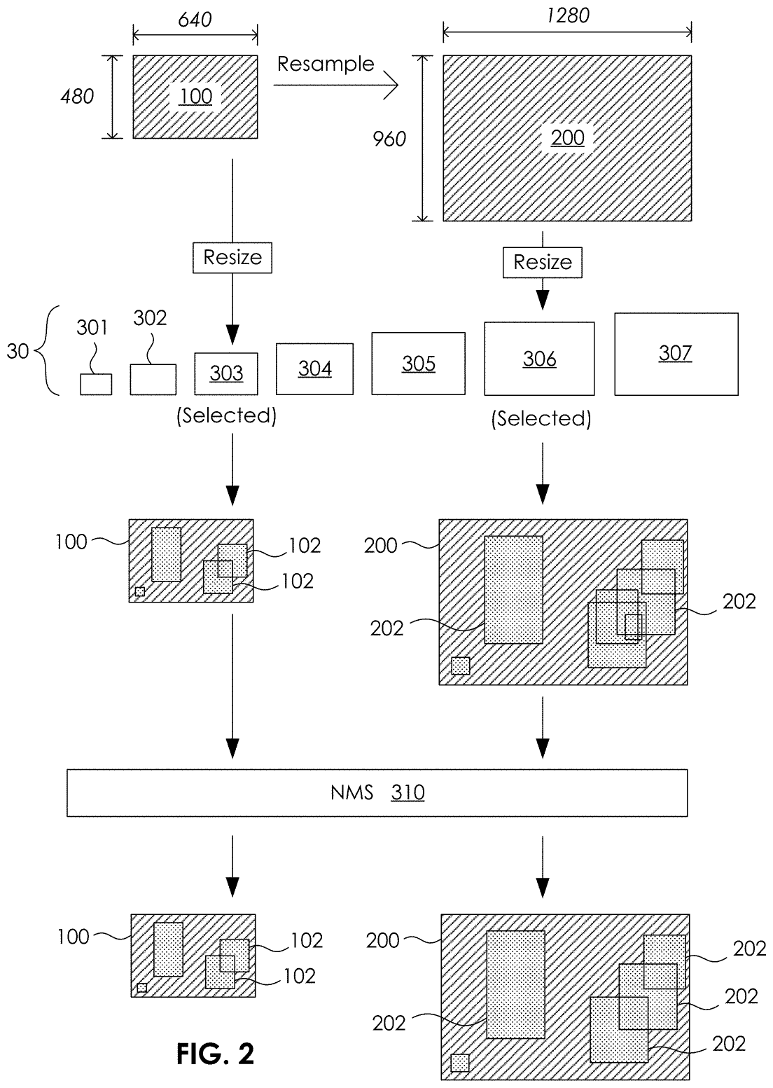

FIG. 2 illustrates a graphical flow chart of some embodiments of the present disclosure and may be used as a reference to better understand the operations illustrated in FIG. 1. As shown in the figure, the first image 100 is appointed as the subject that is to be recognized. The first image 100 has a native resolution. Generally, the image resolution can be described in different aspects. For example, the image resolution can be described in PPI, which refers to how many pixels are displayed per inch of an image; while in other examples, the image resolution can be described in pixels height by pixels wide, such as 640×480 pixels, 1280×960 pixels, etc. The embodiments in the present disclosure use the latter description but are not limited to the format in description of the image resolution.

In order to enhance the quality of the first image 100, in some embodiments, the first image 100 can be resampled to generate the second image 200 at the very beginning of the analysis process. The second image 200 can have a resampled resolution greater than the native resolution in pixel number. For example, in the case of the first image 100 having a native resolution of 640×480 pixels, the second image 200 can be resampled to have a resampled resolution of 1280×960 pixels. In other words, the first image can be upsampled in the resampling operation by a magnification ratio such as 2×.

In some embodiments, the resampling operation or the upsampling operation includes the operation to perform a super-resolution (SR) process on the first image to form the second image having a resolution greater than the native resolution. To be more detailed, the super-resolution process is the process of recovering high-resolution (HR) images (e.g., the second image 200 having the resampled resolution) from low-resolution (LR) images (e.g., the first image 100 having the native resolution), and thus the low-resolution images are upscaled accordingly. In some embodiments of the present disclosure, the super-resolution process is trained by deep learning techniques. That is, deep learning techniques can be used to generate the high-resolution image when given the low-resolution image, and by using supervised machine learning approaches as the functions from low-resolution images to high-resolution images can be mapped from a large number of given examples. In other words, there can be several super-resolution models that are trained with low-resolution images as input and high-resolution images as targets. The mapping function learned by these models is the inverse of a downgrade function that transforms high-resolution images into low-resolution images.

To implement the resampling operation, the super-resolution models can be selected depending on the characteristics of the models. For example, there are some established super-resolution models that are quality-oriented such as ESRGAN, RealSR, EDSR, and RCAN; some established super-resolution models are arbitrary super-resolution magnification ratio such as Meta-SR and, LIIF, and UltraSR; and some established resolution models are comparatively more effective such as RFDN and PAN.

In some embodiments, the magnification ratio in the resampling operation through the super-resolution process is performed with an integer magnification factor, such as 2×, 3×, 4×, etc. In other embodiments, the magnification ratio in the resampling operation through the super-resolution process can be performed with any magnification factor, such as 1.5×, 2.4×, 3.7×, etc. Generally, the magnification factor is based on the default of the established super-resolution models.

Since model efficiency has become increasingly important in computer vision, the efficiency in object detection has been improved by building a series of scalable detection models. For instance, by scaling the resolution, depth, and width for all backbone, feature network, and box/class prediction networks at the same time, a family or a collection of scalable models for object detecting can be developed to provide a better balance between both accuracy and efficiency. In some embodiments, the objects in the first image 100 and the second image 200 can be detected in the subsequent detecting operation. In some embodiments, the first scalable model collection 30 includes a plurality of (scalable) detection models 301-307 to be selected for detection of the objects in the images.

In other words, the object detection models in the family or the collection may have different levels of complexity and the capacity to adapt to different scales of input images. In some embodiments, the objects in the first image 100 and the second image 200 can be detected by using separate detection models of the first scalable model collection 30. For example, the detection model 303 is assigned to detect the first image 100, whereas the detection model 306 is assigned to detect the second image 200. The detection model 306 is more complicated than the detection model 303. One of the purposes of the present disclosure is to apply a comparatively appropriate detection model picked out of the first scalable model collection 30 to detect the objects in the image.

In some embodiments, the detection models of the first scalable model collection 30 are selected depending on the size of the image. That is, different detection models of the first scalable model collection 30 may correspond to different input sizes of the images. For example, one of the detection models may be designed to have an input resolution of 512×512 pixels, while others may be designed to have an input resolution of 640×640 pixels, 1024×1024 pixels, 1280×1280 pixels, etc. By increasing the input resolution, the accuracy of the detection model is increased as well. Overall, the detection models of the first scalable model collection 30 have an order of ascending average precision.

In some embodiments, the image analysis process of the present disclosure may select the detection models having the input resolution that is closest to the first image 100 and the second image 200, respectively. For example, in the case of the first image 100 having a native resolution of 512×512 pixels, the detection model that is designed to have an input resolution of 512×512 pixels would be selected. In other words, the first image 100 will be assigned to one of the detection models based on the closeness of the input resolution to its image size. Similarly, in the case of the second image 200 being generated from the first image 100 by a magnification ratio of 2×, the second image 200 may have a resampled resolution of 1024×1024 pixels, and therefore the detection model that is designed to have an input resolution as 1024×1024 pixels would be selected. That is, the second image 200 will be assigned to one of the detection models based on the closeness of the input resolution to its image size. At least two different detection models of the first scalable model collection 30 are selected accordingly.

In some embodiments, the image analysis process performs an operation to determine the magnification ratio according to the input resolutions of the first scalable model collection 30. That is to say, the magnification ratio is initiatively determined based on the detection models been selected. For example, since the input resolution of one of the detection models is 512×512 pixels and the input resolution of another detection model is 1024×1024 pixels, the first image 100 having a native resolution of 512×512 pixels can be resampled by a magnification ratio of 2× to fulfill the pre-selected detection models.

Considering that an image is not always square in size, in some embodiments, the image analysis process of the present disclosure may further cause the computing devices to perform operation 911 (see FIG. 1): resizing the first image and the second image according to the first scalable model collection. That is, the first image 100 and the second image 200 are resized according to the selected detection models prior to detecting the objects in those images. For example, in the case of the first image 100 having a native resolution of 640×480 pixels, the first image 100 will be resized to 640×640 pixels prior to the object detection operation. In the scenario that the first image 100 and/or the second image 200 are resized, the image analysis process of the present disclosure may subsequently cause the computing devices to perform an operation to select a first detection model from the first scalable model collection according to the size of the resized first image, and to select a second detection model from the first scalable model collection according to the size of the resized second image.

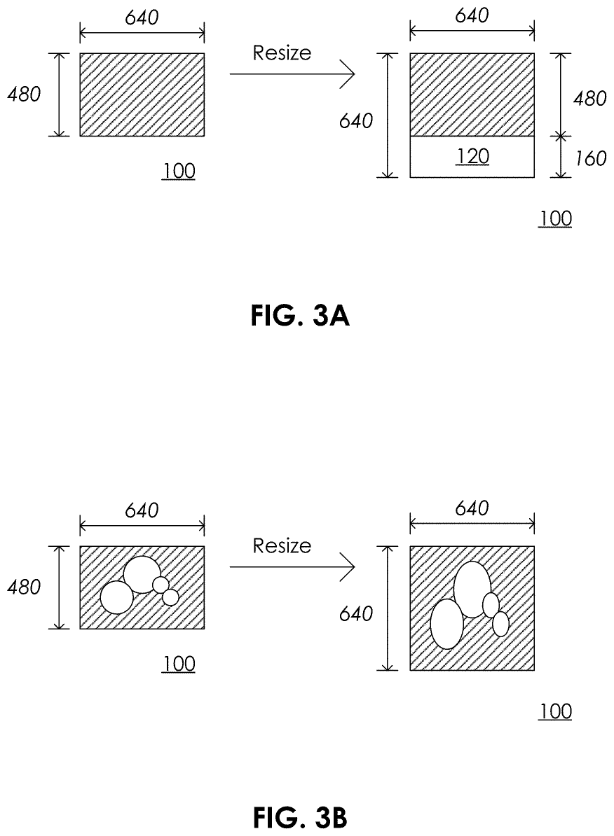

As shown in FIG. 3A, in the operation of resizing the first image 100, the width and/or the length differences between the resolution of the image and the input resolution of the detection model can be compensated by adding additional pixels into the image. For instance, in the case of the first image 100 having a native resolution of 640×480 pixels, a compensated region 120 having a size of 640×160 pixels can be combined with the first image 100, and thus the first image 100 is resized to 640×640 pixels.

Referring to FIG. 3B, in other embodiments, the first image 100 can be resized by adjusting the aspect ratio of the first image 100 to get its length-width ratio become 1:1. In such embodiments, the size change in different directions can be different, and therefore the objects in the images might be deformed to some acceptable degree.

Moreover, the abovementioned techniques in resizing the first image 100 can be implemented to the second image 200 as well.

In the previously mentioned example that the first image 100 has a native resolution of 640×480 pixels, the second image 200 may be generated from the first image 100 by a magnification ratio of 2× and then has a resampled resolution of 1280×960 pixels accordingly. In such example, the second image 200 can be resized to 1280×1280 pixels prior to the object detection operation to fulfill the requirement of matching the input resolution of the detection model.

In some embodiments, the order of the resampling operation of the first image 100 and the size-fixing operation of the image(s) can be altered. That is, the first image 100 can be resized to match the input resolution of the detection model before the generating of the second image 200, and therefore it is possible to waive the size-fixing operation of the second image 200.

In the present disclosure, the accuracy of the object detection is one of the concerns about the analysis process. To ensure the accuracy of the object detection, one of the features provided in the present disclosure is to implement the object detecting operation on both of the first image 100 and the second image 200. That is, since the resolution of the first image 100 is comparatively low and the detection model selected for the first image 100 is comparatively simple, it is possible that one or more objects are missing in the object detecting operation. To address it, the first scalable model collection is applied to not only the first image 100, but also the second image 200. In so doing, object detection is also performed on a resampled image having such a larger size in pixels and under the working of comparatively complicated detection model. The second image 200 is therefore used to alleviate the missing of objects in detection.

Still referring to FIG. 2, the object detection may provide one or more bounding boxes to indicate each object of interest in the images. Each of the bounding boxes is referred to as a patch. In some embodiments, a plurality of first patches 102 in the first image 100 and a plurality of second patches 202 in the second image 200 are detected by the abovementioned separate detection models of the first scalable model collection. The first patches 102 and the second patches 202 are referred to as the detected objects.

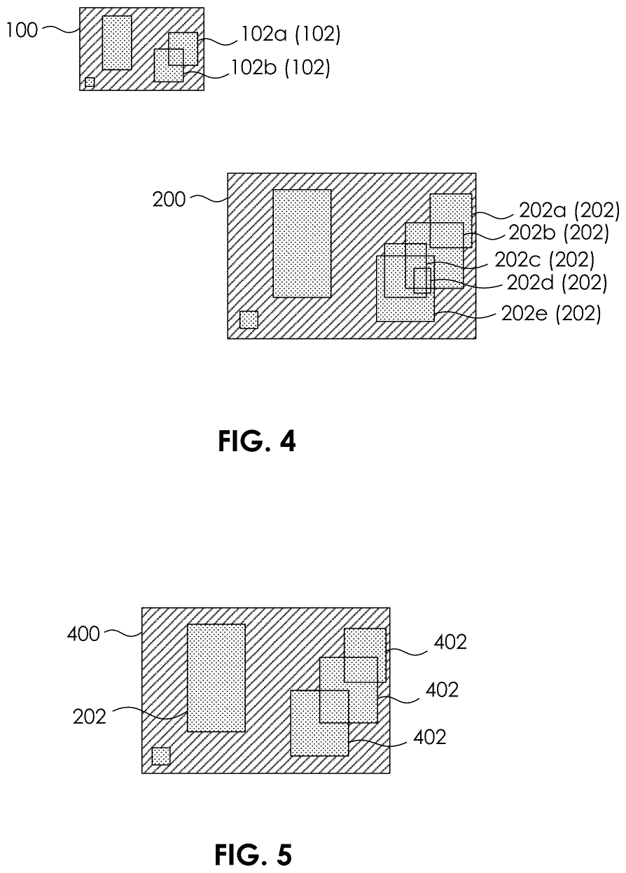

Since the second image 200 is detected by a comparatively complicated detection model, it is possible to gain a much more complete detection result. Accordingly, the quantity of the second patches 202 may be greater than the quantity of the first patches 102. In some circumstances, there are some overlaps between the patches. For example, as the bounding boxes shown in FIG. 4, the first patches 102a-b are detected in the first image 100 while the second patches 202a-e are detected in the second image 200 with respect to the corresponding region. Note that the bounding boxes of these second patches significantly overlap each other. In such circumstances, some of the patches can be removed to improve the efficiency of the analysis process.

Back to FIG. 2, in some embodiments, a Non-Maximum Suppression (NMS) technique is applied to select a single object or patch out of many overlapping objects or patches. Briefly, the Non-Maximum Suppression is a class of algorithms to select one entity (e.g., bounding boxes) out of many overlapping entities, and it is allowed to choose the selection criteria to arrive at the desired results. Generally, the selection criteria can be some form of probability number and some form of overlap measure (e.g., Intersection over Union, IoU), for example, to remove overlapping bounding boxes with IoU≥0.5.

In some embodiments, after detecting the first patches 102 and the second patches 202 in the first image 100 and the second image 200, respectively, the output aggregation operation (i.e., the operation 93 shown in FIG. 1) may be executed subsequently to aggregate the first patches 102 and the second patches 202. Accordingly, a third image 400 can be obtained by aggregating the first patches 102 and the second patches 202 with removal of overlaps. The third image 400 is the final detection result of the stage of object detection. Note that the first patches 102 detected from first image 100 need to be upscaled for adaption to the third image 400.

As shown in FIG. 5, it can be observed that there are a number of third patches 402 (i.e., the bounding boxes) drawn in the third image 400. These third patches 402 are the objects detected from the first image 100 and the second image 200 using the detection models of the first scalable model collection, and further, be aggregated with the deletion of overlapping objects. In some embodiments, the third image 400 is generated based on the second image 200, and therefore the resolution of the third image 400 is identical to the resolution of the second image 200.

In some embodiments, the analysis process of the image is to figure out the classification of the image. After the objects in the original image (i.e., the first image 100) are detected and the quality of the image is enhanced by the super-resolution process, these detected objects (i.e., the third patches 402) will be further classified. The substantial content or subject of the image can be inferred from the classification.

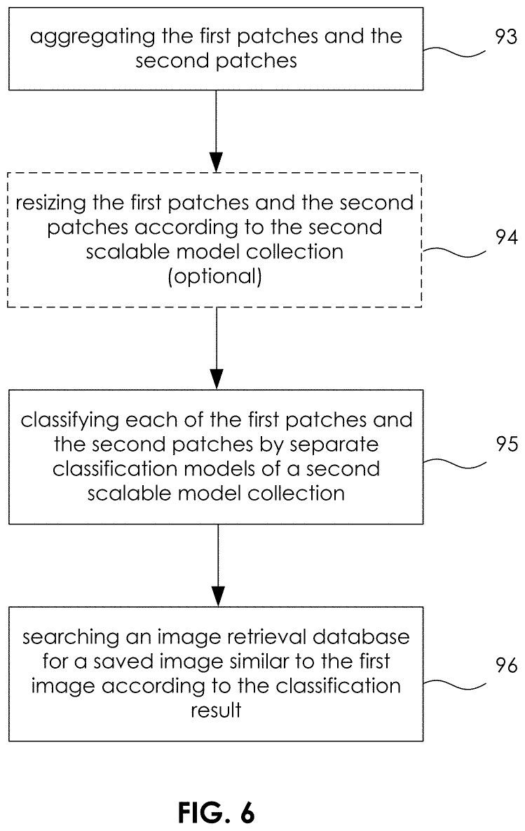

Referring to the flow chart in FIG. 6, in some embodiments, the analysis process of the present disclosure may cause the computing devices to perform the operation 95: classifying each of the first patches 102 and the second patches 202 by separate (scalable) classification models of a second scalable model collection. That is, the second patches 202 and the first patches 102 are both classified by one or more classification models selected from the second scalable model collection. Even though the first patches 102 are detected from the original image which has a comparatively low resolution, these patches still participate as the targets in the classification operation to enhance the accuracy.

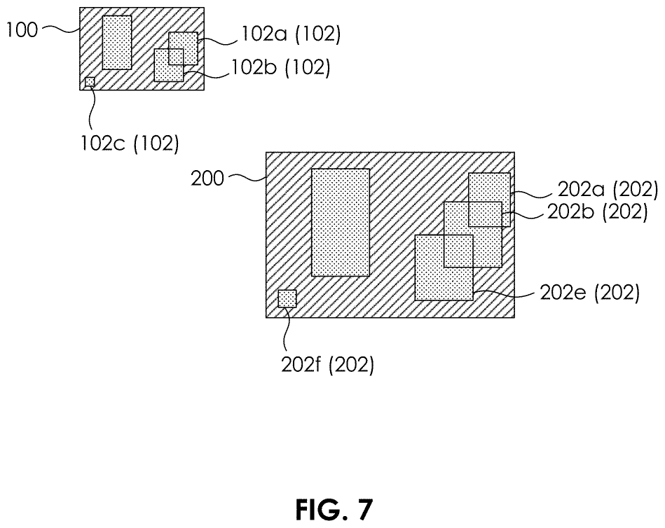

In some embodiments, the analysis process may cause the computing devices to perform an operation to determine whether to drop one or more first patches 102 and/or second patches 202 prior to classifying these patches. In some embodiments, a classifier dispatcher can be applied to drop the patches that are not going to be classified because of poor quality. As shown in FIG. 7, the sizes of the first patches 102 (or the second patches 202) may not be the same. If the resolution of the first image 100 is too low, it is difficult to identify the content of the small-size first patches 102 effectively. In some embodiments, the classifier dispatcher can drop some of the first patches 102 that have a size lower than a threshold. For example, the first patch 102c in FIG. 7 might be dropped for being extremely small while the second patch 202f with respect to a region corresponding to the first patch 102c can be retained for the better resolution of the second image 200. In some embodiments, the dropped patch has a size smaller than the beginning level of the classification model of the second scalable model collection. For example, in the case that the smallest input resolution of the classification model of the second scalable model collection is 224×224 pixels, the first patch 102 having a resolution of 100×100 pixels would be dropped by the classifier dispatcher. If the resolution of each of the first patches 102 and the second patches 202 is higher than the threshold, there is no need to drop any patches.

In some embodiments, only the patches kept after the previously mentioned aggregating operation will be managed by the classifier dispatcher. That is, the classifier dispatcher does not have to deal with all of the first patches 102 and the second patches 202 detected by the first scalable model collection 30 because some of the patches might be deleted by the Non-Maximum Suppression as previously mentioned.

In some embodiments, the classification models of the second scalable model collection are selected depending on the size of the patches. For example, one of the classification models may be designed to have an input resolution of 224×224 pixels, while others may be designed to have an input resolution of 240×240 pixels, 260×260 pixels, 300×300 pixels, etc. In some examples, the input resolution can be designed up to 600×600 pixels. By increasing the input resolution, the accuracy of the classification model is increased as well. Overall, the classification models of the second scalable model collection 50 have an order of ascending average precision.

Since the sizes of first patches 102 and the second patches 202 are corresponding to the sizes of the objects per se, basically, there is no regularity in the sizes of the first patches 102 and the second patches 202. For example, the first patches 102 may have resolutions such as 250×100 pixels, 300×90 pixels, 345×123 pixels, etc., featuring higher variety than the size of the first image 100. Particularly, the size of the first image 100 is usually related to the default setting of the cameras. Therefore, in some embodiments, the analysis process of the present disclosure may further cause the computing devices to perform the operation 94 (see FIG. 6): resizing the first patches 102 and the second patches 202 according to the second scalable model collection prior to classifying these patches.

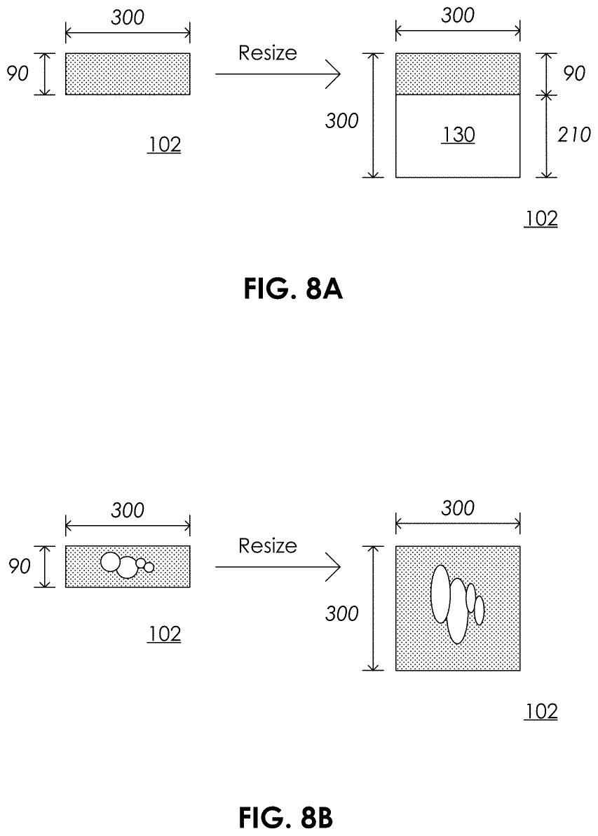

The resizing operation 94 for the first patches 102 and the second patches 202 is similar to the resizing operation 911 previously mentioned in matching the size of an image to the input resolution of a detection model within the first scalable model collection 30. For example, as shown in FIG. 8A, in the case of a first patch 102 having a resolution of 300×90 pixels, additional pixels can be added into the first patch 102 to form a compensated region 130 having a size of 300×210 pixels, and the first patch 102 is thus resized to 300×300 pixels. In other embodiments, referring to FIG. 8B, the length-width ratio of the first patch 102 can be changed directly by enlarging the patches in one of the directions to match the patch sizes to the input resolution of classification models. In alternative embodiments, the length-width ratio of the first patch 102 can be changed by compressing the patches to match the patch sizes to the input resolution of classification models. The compression can be an option if the patch size of the first patch 102 is slightly larger than the input resolution of classification models.

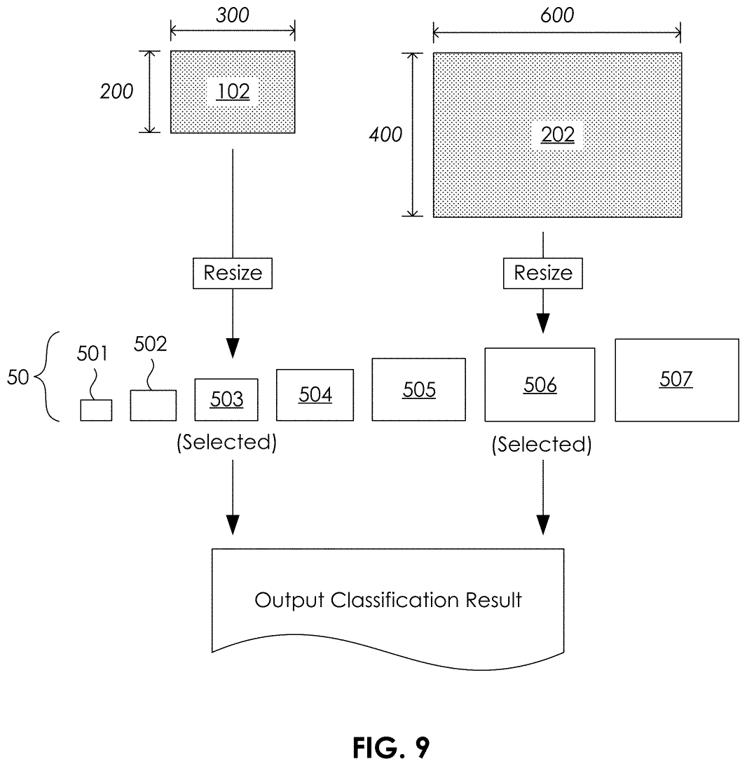

Referring to FIG. 9, by assigning the first patches 102 and the second patches 202 to the classification models 501, 502, 503, 504, 505, 506, or 507 of the second scalable model collection 50, the image analysis process can performs classification on the first patches 102 and the second patches 202 with the classification models selected from the second scalable model collection 50 to produce the classification result including one or more categories of the object in each of the patches. Because the resolution of the first image 100 is lower than that of the second image 200, the quality of the first patches 102 is poorer than that of the second patches 202 in general. Therefore, the first patches 102 carry less weight than the second patches 202 in determining the categories of the patches. In other words, the image with high resolution, i.e., the second patches 202 detected from the second image 200, makes a major contribution to the final classification result.

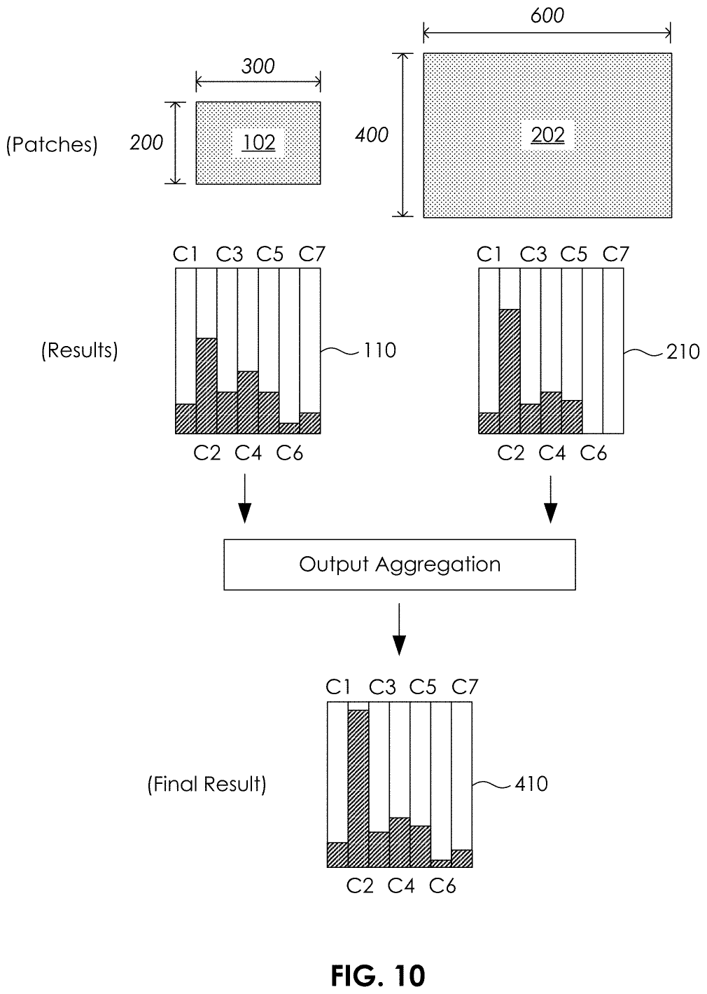

FIG. 10 illustrates an example of the classification result. As shown in the figure, both the first patch 102 and the second patch 202 may be classified into a plurality of predicted categories. In the example of FIG. 10, the classification by scalable models produces a first list 110 of the predicted categories for the first patch 102 and a second list 210 of the predicted categories for the second patch 202. The dark bar marked in each of the categories C1-C7 stands for a score indicating the predication result of a patch. The higher the bar, the higher the score. Moreover, the classification includes the operation of output aggregation shown in FIG. 10 to aggregate the first list 110 and the second list 210 by averaging, weighted summation, or finding the maximum, etc. For instance, the output aggregation operation can output a third list 410 as the final result of the classification, which is derived from a function of weighted sum on the scores for each category.

In some embodiments, the output aggregation operation gives priority to the second list 210 owing to the better quality of the second patch 202. Only the score of a category in the second list 210 can be trusted and kept once the same category in the first list 110 has a considerably different score. In other words, the first list 110 plays an auxiliary or reference role in determining the classification result. For instance, the first list 110 may help confirm the predicted categories in the second list 210 or may be used to adjust the ranking of the predicted categories in the second list 210 if their scores are very close.

In some embodiments, all details of the classification result (e.g., the first list 110 and the second list 210) will be saved into a database, and the category having the highest score will be displayed as the classification result of the patch. That is, each of the second patches 102 may be labeled with the classified category in text form after the object detection operation 92 and the classification operation 95. The remaining categories that are not displayed will be saved as sub-labels for further reverse image searching applications.

In the case that Non-Maximum Suppression is not applied to delete overlapping object bounding boxes, each of the patches detected through the object detection operation of the present disclosure or acquired from other sources will be classified in the classification operation. In such embodiments, the patches with IoU above a threshold (e.g., IoU≥0.5) can be regarded as the same object, and only the one with the best confidence will be kept in presenting the classification result.

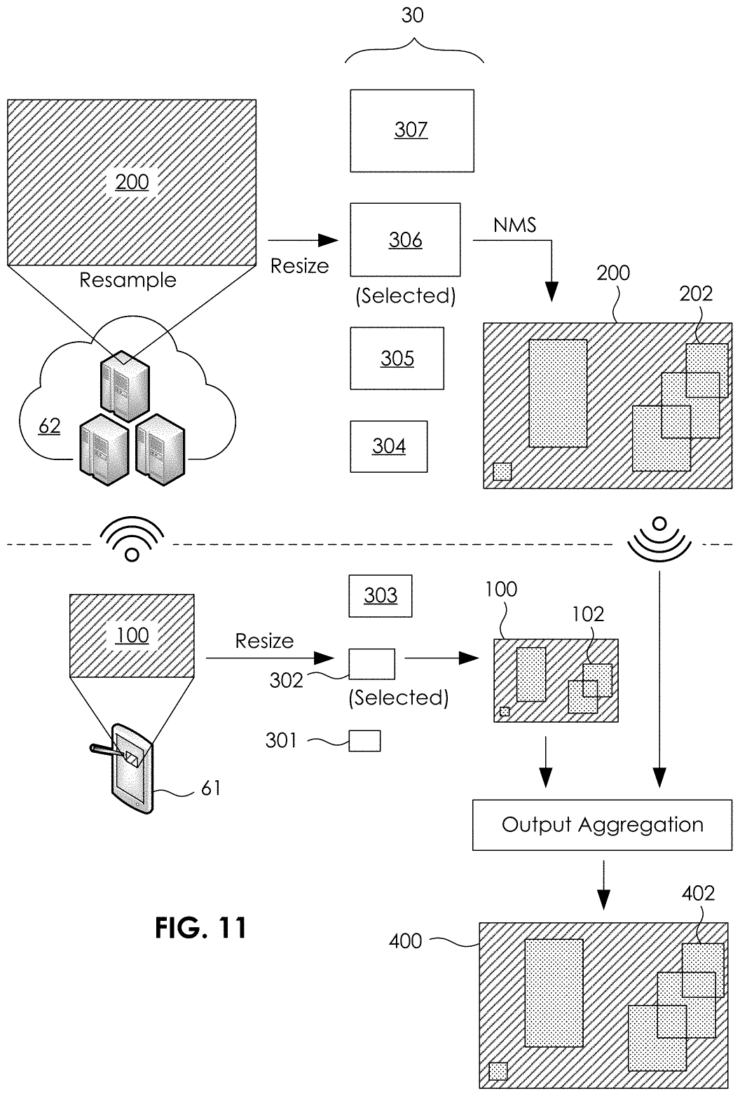

FIG. 11 illustrates a system for processing images in accordance with some embodiments of the present disclosure. As previously mentioned, the image recognition of the present disclosure is running on far-end computing devices since the computing tasks can be executed by centralized computer servers with incredible computing power. In those embodiments, the first image 100, which has a comparative low resolution and small file size, is transmitted from a consumer electronics 61 to a centralized computer server (hereinafter “cloud server 62”) through a feasible communication technique. The cloud server 62 may handle most of the computing tasks such as the resampling operation 91 for generating the second image 200 from the first image 100, the resizing operation 911 on the second image 200 (if necessary), and the detection operation 92 for detecting the second patches 202. In some embodiments, the resizing operation 911 on the first image 100 (if necessary) and the detection operation 92 for detecting the first patches 102 can be executed by the consumer electronics 61 because the resolution of the first image 100 is not very high and the detection models employed are comparatively simple. After receiving the detection result from the cloud server 62, the aggregation operation 93 can be executed on the consumer electronics 61 to output the prediction of the objects in the second image 200.

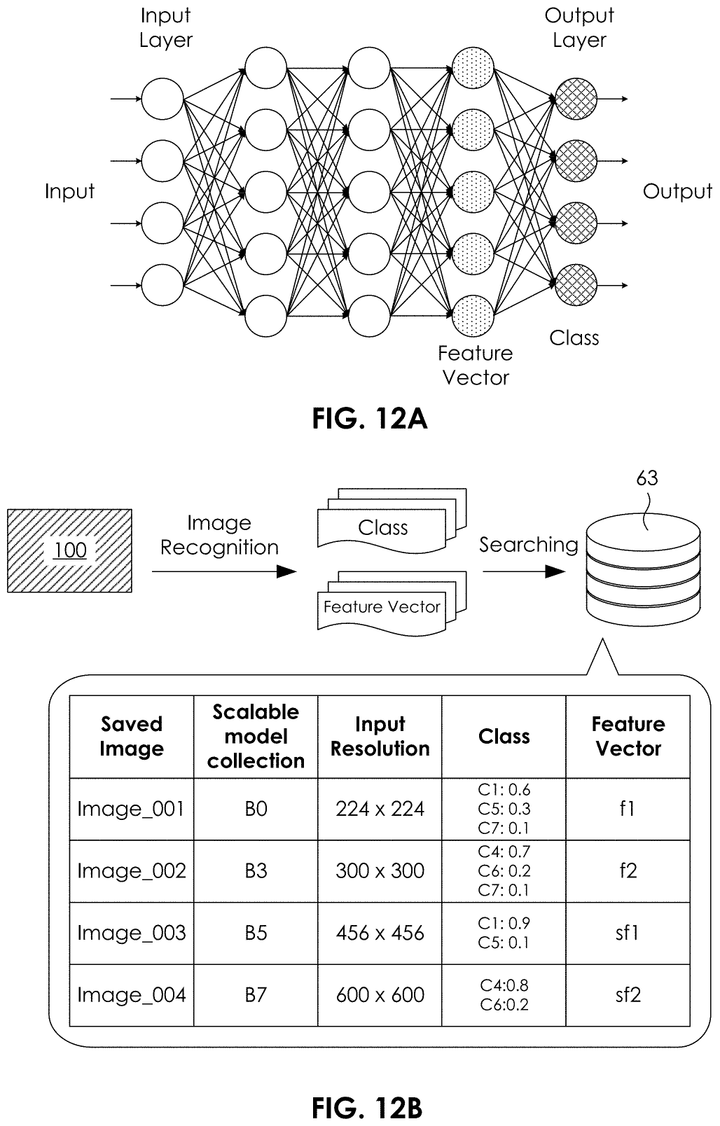

After the classification operation 95, in some embodiments, the analysis process further causes the computing devices to perform an optional operation 96: searching an image retrieval database for a saved image similar to the first image 100 (input image) according to the classification result. As previously mentioned, the details of the classification result will be saved in a database, and the saved classification result may include not only the description text of the category but also the feature vectors associated with the classes in the deep layers of the selected classification models. Referring to FIG. 12A, the category is the output layer of the deep learning neural network of the selected classification model, and the feature vectors are the deep layers that are in proximity to the output layer of the neural network of the classification model. Due to the architecture of deep learning neural networks, these feature vectors are critical factors in determining the output of the neural network. Referring to FIG. 12B, in some embodiments, the information regarding the selected classification model, the classes of the image (i.e., the top several predicted categories of the image), and the feature vectors are saved in the image retrieval database 63. The scalable models B0, B3, B5, B7 are illustrated as an example in terms of the scalable classification model collection 50 shown in FIG. 9. The operation 96 also involves comparing the feature vector of the upsampled image 200 and at least a saved feature vector in the image retrieval database for each of the selected classification models by means of similarity calculation as described below.

The image retrieval database 63 can be a meta-database designed for large-scale storage systems. By providing a huge amount of image recognition results to the image retrieval database in advance (i.e., the saved images in FIG. 12B), the accuracy in reverse image searching can be significantly improved. Any query about an input image is parsed as one or more classes and feature vectors by one or more classification models, which are selected through the process as described earlier. While doing the search it takes into account the selected classification models together with the feature vectors. Turning back to FIG. 12A as an example, only those entries that are associated with a selected classification model would be considered and just the similarity between the feature vector coming from the considered entries and the feature vector of the same classification model derived from the upsampled image 200 (and optionally, the input image 100) is calculated. The similarity calculation would be performed for all of the selected classification models to match up the input image with an image saved in the database. Therefore, a saved image that is the best match to the input image (i.e., the first image 100) can be located in the image retrieval database 63. In some embodiments, the feature vectors are the most important factor utilized in searching similar images.

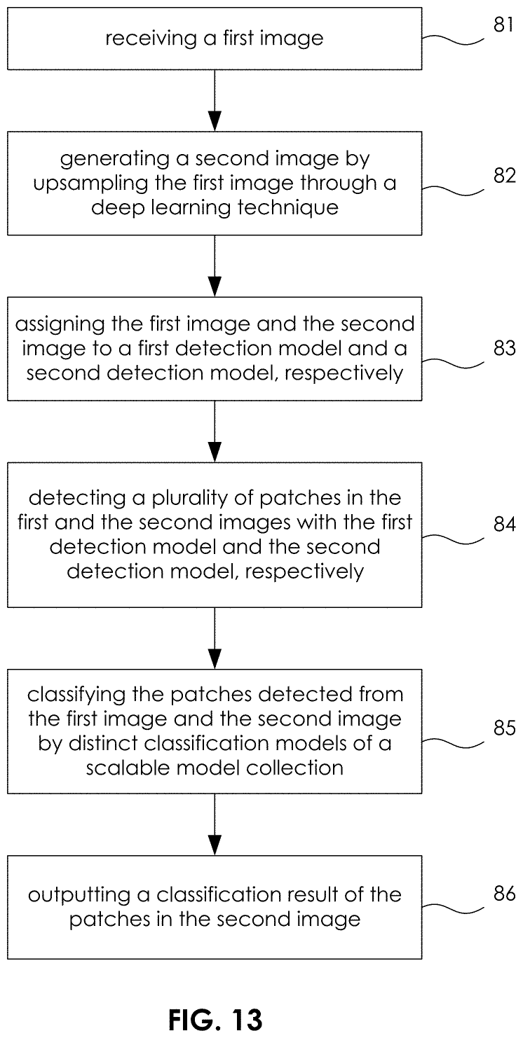

According to the above disclosed image processing system with scalable models and the principles and mechanisms thereof, a method for processing an image with scalable models can be derived therefrom. Hence, FIG. 13 illustrates a flow chart of a method for processing an image according to some embodiments of the present disclosure. As shown in the figure, the method includes an operation 81: receiving a first image; an operation 82: generating a second image by upsampling the first image through a deep learning technique; an operation 83: assigning the first image and the second image to a first detection model and a second detection model, respectively; an operation 84: detecting a plurality of patches in the first and the second images with the first detection model and the second detection model, respectively; an operation 85: classifying the patches detected from the first image and the second image by distinct classification models of a scalable model collection; and an operation 86: outputting a classification result of the patches in the second image.

In some embodiments, the deep learning technique is a pre-trained super-resolution model which can multiply a pixel number of the first image 100, such as the example of FIG. 2 showing that the first image 100 is upsampled by a magnification ratio of 2×. In some embodiments, the first detection model and the second detection model are scalable models of a baseline network, and these models belong to a single scalable model collection. However, the models for classifying the patches are different from this scalable model collection having the first detection model and the second detection model. That is, there are different scalable model collections that can be used in accordance with the present disclosure, such as the first scalable model collection 30 and the second scalable model collection 50 previously shown in FIG. 2 and FIG. 9. In some embodiments, the detected patches are assigned to the classification models according to a patch size of each patch, such as the example of FIG. 9 showing that the first patches 102 and the second patches 202 are resized to match the selected classification models of the second scalable model collection 50.

Briefly, the present disclosure provides an image processing system with scalable models and a method for processing an image. Particularly, the image processing system includes the use of scalable model collection that can process the images with different resolutions/qualities. Such an image processing system may assign the images or their patches to appropriate models to detect the objects in the images or to classify the objects. Furthermore, the image processing system may perform the post-processing for the outputs of different models by an aggregator; and an input dispatcher can be used to assign the patches with acceptable quality to the appropriate models and drop the patches that fail to reach the threshold. In addition, the image processing system may provide the function in image retrieval by matching the images through comparing features at different feature spaces. Overall, reliable performance in image recognition and content retrieval can be achieved by using the image processing system of the present disclosure.

In one exemplary aspect, an image processing system with scalable models is provided. The image processing system includes one or more computing devices. The one or more computing devices includes a graphic analysis environment. The graphic analysis environment includes instructions to execute an analysis process on a first image having a native resolution. The analysis process causes the one or more computing devices to perform operations includes: resampling the first image to generate a second image, wherein the second image has a resampled resolution greater than the native resolution in pixel number; detecting a plurality of first patches and a plurality of second patches in the first image and the second image, respectively, wherein the first patches and the second patches are detected by separate detection models of a first scalable model collection according to sizes of the first image and the second image; and aggregating the first patches and the second patches.

In another exemplary aspect, a method for processing an image with scalable models is provided. The method includes the operations below. A first image is received. A second image is generated by upsampling the first image through a deep learning technique. The first image and the second image are assigned to a first detection model and a second detection model, respectively. A plurality of patches in the first and the second images are detected with the first detection model and the second detection model, respectively. The patches detected from the first image and the second image are classified by distinct classification models of a scalable model collection. A classification result of the patches in the second image are outputted.

In yet another exemplary aspect, a method for processing an image with scalable models is provided. The method includes the operations below. A first image is received. A second image is generated from the first image by a magnification ratio. The first image and the second image are assigned to a first detection model and a second detection model of a first scalable model collection, respectively. A plurality of first patches and a plurality of second patches are detected in the first image and the second image, respectively. The second patches are classified by a plurality of classification models of a second scalable model collection according to sizes of the second patches. The first patches and the second patches are aggregated to generate a classification result.

The foregoing outlines structures of several embodiments so that those skilled in the art may better understand the aspects of the present disclosure. Those skilled in the art should appreciate that they may readily use the present disclosure as a basis for designing or modifying other operations and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An image processing system with scalable models, comprising:
one or more computing devices comprising a graphic analysis environment, wherein the graphic analysis environment comprises instructions to execute an analysis process on a first image having a native resolution, the analysis process causes the one or more computing devices to perform operations comprising:
resampling the first image to generate a second image, wherein the second image has a resampled resolution greater than the native resolution in pixel number;
detecting a plurality of first patches and a plurality of second patches in the first image and the second image, respectively, wherein the first patches and the second patches are detected by separate detection models of a first scalable model collection according to sizes of the first image and the second image; and
aggregating the first patches and the second patches.

2. The image processing system of claim 1, wherein the operation of resampling comprises performing a super-resolution process on the first image to form the second image having a resolution greater than the native resolution.

3. The image processing system of claim 1, wherein the analysis process further causes the computing devices to perform an operation to resize the first image and the second image according to the first scalable model collection prior to detecting the first patches and the second patches.

4. The image processing system of claim 3, wherein the analysis process further causes the computing devices to perform an operation to select a first detection model from the first scalable model collection according to a size of the resized first image, and to select a second detection model from the first scalable model collection according to a size of the resized second image.

5. The image processing system of claim 1, wherein the analysis process further causes the computing devices to perform operations comprising:
classifying the second patches by separate classification models of a second scalable model collection; and
outputting a classification result of the second image.

6. The image processing system of claim 5, wherein the analysis process further causes the computing devices to perform operations comprising:
classifying the first patches by one or more classification models selected from the second scalable model collection; and
outputting a classification result of the first image.

7. The image processing system of claim 5, wherein the analysis process further causes the computing devices to perform an operation to resize the first patches and the second patches according to the second scalable model collection prior to classifying the first patches and the second patches.

8. The image processing system of claim 5, wherein the analysis process further causes the computing devices to perform an operation to determine whether to drop one or more first patches prior to classifying the first patches.

9. The image processing system of claim 1, wherein the analysis process further causes the computing devices to perform an operation to search an image retrieval database for a saved image similar to the first image according to the classification result of the second image.

10. A method for processing an image with scalable models, the method comprising:
receiving a first image;
generating a second image by upsampling the first image through a deep learning technique;
assigning the first image and the second image to a first detection model and a second detection model, respectively;
detecting a plurality of patches in the first and the second images with the first detection model and the second detection model, respectively;
classifying the patches detected from the first image and the second image by distinct classification models of a scalable model collection; and
outputting a classification result of the patches in the second image.

11. The method of claim 10, wherein the deep leaning technique is a pre-trained super-resolution model configured to multiply a pixel number of the first image.

12. The method of claim 10, wherein the first detection model and the second detection model are scalable models of a baseline network.

13. The method of claim 10, wherein the detected patches are assigned to the classification models of the scalable model collection according to a patch size of each patch.

14. The method of claim 10, wherein the first detection model and the second detection model belong to another scalable model collection.

15. The method of claim 10, further comprising:
searching an image retrieval database for a saved image similar to the first image according to the classification result.

16. The method of claim 15, wherein the classification result comprises a plurality of classes and a plurality of feature vectors associated with the classes.

17. The method of claim 16, wherein the searching operation comprises:
comparing the feature vector of the second image and at least a saved feature vector in the image retrieval database.

18. A method for processing an image with scalable models, the method comprising:
receiving a first image;
generating a second image from the first image by a magnification ratio;
assigning the first image and the second image to a first detection model and a second detection model of a first scalable model collection, respectively;
detecting a plurality of first patches and a plurality of second patches in the first image and the second image, respectively;
classifying the second patches by a plurality of classification models of a second scalable model collection according to sizes of the second patches; and
aggregating the first patches and the second patches to generate a classification result.

19. The method of claim 18, further comprising:
determining the magnification ratio according to a plurality of input resolutions of the first scalable model collection.

20. The method of claim 18, further comprising:
saving a plurality of predicted categories of the classification result into a database; and
only displaying a predicted category having a highest score in the classification result.
